(19) United States
(12) Patent Application Publication
(10) Pub. No.: US 2003/0034209 A1
(43) Pub. Date: Feb. 20, 2003

(54) Wireless transmission control apparatus for elevator systems

(75) Inventors: Po-Loung Tang, Taipei (TW); Lin Chin Lung, Taipei (TW); Lin Chen Han, Taipei (TW)

Correspondence Address: BRINKS HOFER GILSON & LIONE, NBC Tower - Suite 3600, 455 North Cityfront Plaza Drive, Chicago, IL, 60611-5599, US

(73) Assignee: Golden Friends Corporation

(21) Appl. No.: 09/932,614

(22) Filed: Aug. 16, 2001

(51) Int. Cl. B66B 1/16

(52) U.S. Cl. 187/247; 187/380

(57) ABSTRACT

A wireless transmission control apparatus is used to control movement of an elevator car of an elevator system that is installed in a building, and includes a wireless car calling unit for transmitting a car calling signal wirelessly, a main control unit associated with a machine room of the elevator system, and a car control unit associated with the elevator car. The main control unit includes a machine room transceiver device for receiving the car calling signal, determines whether the car calling signal is legitimate and a right of priority service for the legitimate car calling signal, and wirelessly transmits a car dispatch signal corresponding to the legitimate car calling signal. The car control unit includes a car transceiver device for receiving the car dispatch signal. The car control unit controls the elevator car to move to a specific floor of the building in response to the car dispatch signal.

### BACKGROUND OF THE INVENTION

1. Field of the Invention

The invention relates to a control apparatus for elevator systems, more particularly to a wireless transmission control apparatus that utilizes wireless transmission to achieve cable material cost savings, convenient installation, passenger identification, and safe maintenance.

2. Description of the Related Art

In a conventional elevator system, the transmission of signals between a machine room and an elevator car falls into two main types:

1. The transmission of signals between the elevator car and the machine room is achieved in a one signal-to-one connecting cable fashion. A drawback of such transmission resides in that the more the number of signals or the number of floors in a building, the greater the amount of cables that are required. More cables means increased car weight and increased cable material and installation costs. Besides, if the functions of the elevator system have to be changed or increased after installation has been completed, considerable time and effort will have to be expended.

2. The transmission of signals between the elevator car and the machine room is achieved via serial connection. Although such a manner of transmission can considerably reduce the amount of cables required, the wire materials used in serial communication are costly. Besides, the lengths of the communication wires increase with the number of floors in the building. Moreover, signal interference and attenuation problems worsen with the increasing length of the communication wires.

### SUMMARY OF THE INVENTION

Therefore, the main object of the present invention is to provide a wireless transmission control apparatus for an elevator system that can achieve lower cable material costs, convenient installation and safe maintenance.

According to the present invention, a wireless transmission control apparatus is used to control movement of an elevator car of an elevator system that is installed in a building, and comprises:

at least one wireless car calling unit operable so as to transmit a car calling signal wirelessly;

a main control unit associated with a machine room of the elevator system and including a machine room transceiver device for receiving the car calling signal transmitted by the wireless car calling unit, the main control unit determining whether the car calling signal is legitimate, and disregarding the car calling signal that is deemed not to be legitimate, the main control unit further determining a right of priority service for the car calling signal that is deemed to be legitimate, and wirelessly transmitting a car dispatch signal corresponding to the car calling signal that is deemed to be legitimate; and

a car control unit associated with the elevator car and including a car transceiver device for receiving the car dispatch signal transmitted by the main control unit, the car control unit being adapted to control the elevator car to move to a specific floor of the building in response to the car dispatch signal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic system block diagram of a preferred embodiment of a wireless transmission control apparatus for elevator systems according to the present invention;

FIG. 2 illustrates the format of data in a signal transmitted according to the preferred embodiment;

FIG. 3 is a look-up table showing the serial numbers of objectified transmission signals according to the preferred embodiment;

FIG. 4 is a schematic circuit block diagram showing a machine room transceiver device of a main control unit of the preferred embodiment;

FIG. 5 is a schematic circuit block diagram of a power supply module of the machine room transceiver device of the preferred embodiment;

FIG. 6 is a schematic circuit block diagram showing a car transceiver device of a car control unit of the preferred embodiment;

FIG. 7 is a schematic view illustrating an external hardware framework structure of the power supply module of the car transceiver device of the preferred embodiment;

FIG. 8 is a state transition diagram to illustrate operation of the power supply module of the car transceiver device of the preferred embodiment;

FIG. 9 is a schematic view illustrating the different battery charging conditions;

FIG. 10 is a state transition diagram illustrating the relationship between car calling units and the main control unit;

FIG. 11 is a state transition diagram illustrating the relationship between a maintenance personnel car calling unit and the main control unit;

FIG. 12 is a state transition diagram illustrating the operation of the machine room transceiver device of the main control unit of the preferred embodiment; and

FIG. 13 is a state transition diagram illustrating the operation of the car transceiver device of the car control unit of the preferred embodiment.

### DETAILED DESCRIPTION OF THE PREFERRED EMBODIMENT

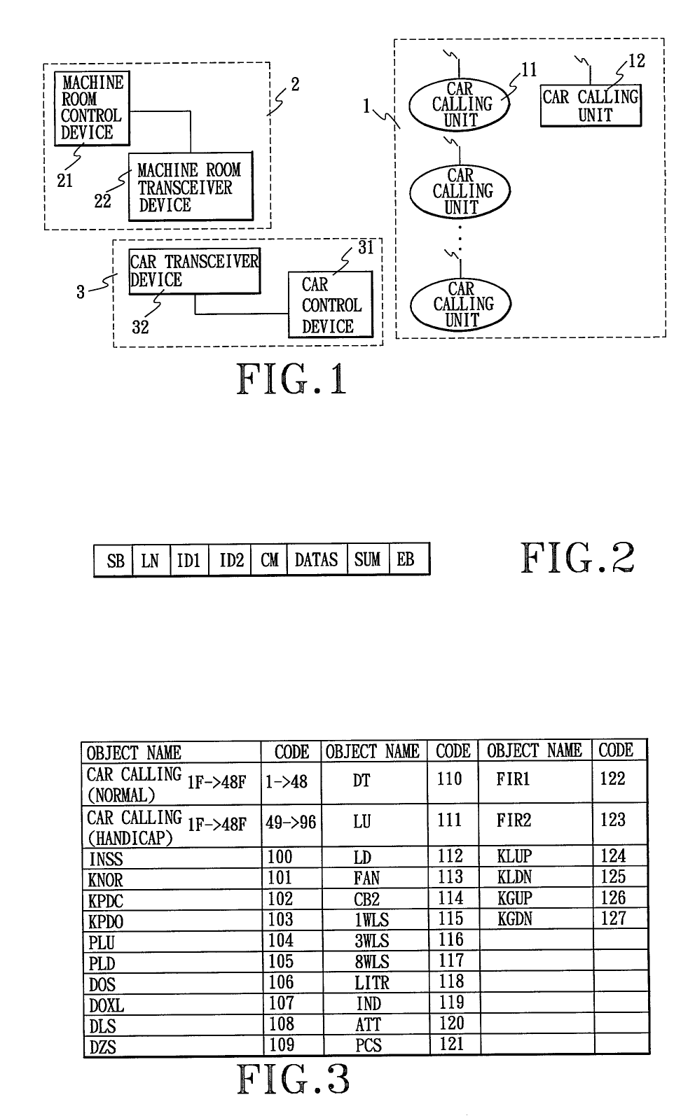

With reference to FIG. 1, the preferred embodiment of a wireless transmission control apparatus according to the present invention is shown to include at least one wireless car calling unit 1, a main control unit 2 and a car control unit 3. The wireless car calling unit 1 can be a car calling unit 11 for passenger use or a car calling unit 12 for use by maintenance personnel The car calling unit 11 is provided to specific individuals who use an elevator system that incorporates the control apparatus of the present invention. According to the invention, an individual who wants to use the elevator system can use the car calling unit 11 on his/her person to transmit a car calling signal from any floor of a building in which the elevator system is installed. It is noted that all of the wireless signals that are transmitted in the control apparatus of this invention use a uniform data transmission format, such as that shown in FIG. 2, in which:

SB: command start identification code, set to be AA;

LN: command content length, i.e., number of bits from LN to EB;

ID1: elevator car serial number, lower bit

ID2: elevator car serial number, higher bit

CM: command parameters, the definitions of which include:

01: origin floor

02: clear all general lighting

03: clear all handicapped lighting

04: I/O ON

05: I/O OFF

06: car calling signal from passenger

07: message transmission, ASCII code

08: car calling signal from maintenance personnel

09: data setting

0A: resetting, for setting object initializing states between machine room and car so as to inform the other party of the object states

0B: online testing, for confirming normal interconnection conditions between two parties

DATAS: data strings to be transmitted, having a length of 1 byte, in which:

Bit0˜Bit3: CRC algorithm value of Bit4˜Bit7;

Bit4˜Bit7: data to be transmitted

SUM: value obtained after performing XOR algorithm upon the data from LN to DATAS;

EB: command end identification code, set to be 55

Furthermore, in order to overcome the problems associated with signal interference and transmission delay resulting from wireless transmission, the control apparatus of the present invention reduces the amount of data in the transmission signals by objectifying all the transmission signals that will be used and assigning serial codes thereto. Hence, every communication will be directed to a single object, and signal communication will be directed only to those objects that will be changed. Besides, the control apparatus of this invention can specify priority classes for these objects.

In the present invention, all the signals are grouped into three types. The first type is I/O signals, which include car calling inputs, peripheral switch inputs, and all the responses and outputs, such as the definitions of 02, 03, 04, 05, 06, 08, 09, 0A and 0B in the CM parameter set forth above. Moreover, each I/O signal is considered to be a single object according to the concept of objectification. There are two characteristics for each object, i.e., input only or output only. In addition, each object has an exclusive serial code for identification purposes, as shown in FIG. 3. The second type includes floor indicating signals, which may be floor codes, malfunction codes, maintenance codes, etc., for input only. The third type includes a message box that accepts ASCII codes, for input only.

In addition, in order to ensure the accuracy of the transmitted data as well as accurate reception of data, detection of errors in the transmitted data has to be strengthened. Thus, the control apparatus of the present invention adopts an Xˆ 4+Xˆ 3+1 CRC (cyclic redundancy checking) algorithm as an error detecting methodology with respect to the data in DATAS. This methodology ensures accuracy of the data and involves little computation time.

The car calling signal differs from the transmission format described above only in that ID1 is the lower bit of the passenger code, whereas ID2 is the higher bit of the passenger code, and the CM command parameter thereof is 06.

The maintenance personnel car calling unit 12 is provided for use by elevator maintenance personnel. An elevator car of the elevator system can be controlled via the car calling unit 12 so as to move to the floor on which the maintenance personnel are stationed for maintenance.

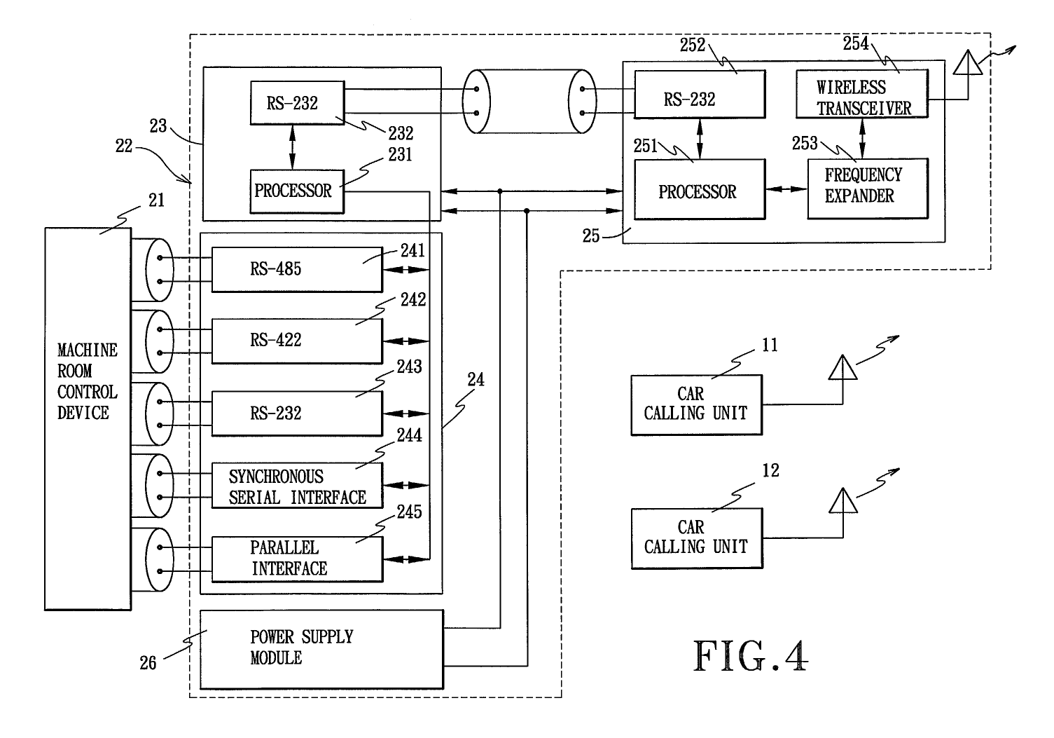

The main control unit 2 includes a machine room control device 21 and a machine room transceiver device 22. The machine room control device 21 is generally disposed in a machine room of the elevator system, and functions in the same way as conventional machine room controllers. As the machine room control device 21 is not crucial to the present invention, a detailed description thereof is dispensed with herein for the sake of brevity. As shown in FIG. 4, the machine room transceiver device 22 includes a control module 23, a connecting interface selector 24, a transceiver module 25, and a power supply module 26.

The control module 23 includes a single-chip processor 231 and an RS-232 interface 232 for interconnecting the single-chip processor 231 and the transceiver module 25.

The connecting interface selector 24 is disposed to connect the machine room transceiver device 22 and the machine room control device 21, and includes a non-asynchronous RS-485 interface 241, a non-asynchronous RS-422 interface 242, a non-asynchronous RS-232 interface 243, a synchronous serial interface 244, and a parallel interface 245 that are respectively connected to the single-chip processor 231 of the control module 23 for selection and use by different machine room control devices 21 so as to meet different electrical interface requirements of the latter.

The transceiver module 25 includes a processor 251 connected to the control module 23 via an RS-232 interface 252, a frequency expander 253, and a wireless transceiver 254. The frequency expander 253 is connected to the wireless transceiver 254, and provides two frequency bands for use by the transceiver 254. The first frequency band has a transmission frequency range of 906.25 MHz˜968.5 MHz. The second frequency band has a reception frequency range of 2.4 GHz˜2.48 GHz. Furthermore, in order to overcome the problem of wireless transmission signal interference associated with the use of public channels, the frequency expander 253 is capable of automatic frequency skipping. That is, when the wireless transceiver 254 transmits a signal, the frequency expander 253 can automatically select and skip to a channel that is available for signal transmission or that is interference-free for signal transmission by the wireless transceiver 254, thereby minimizing signal interference.

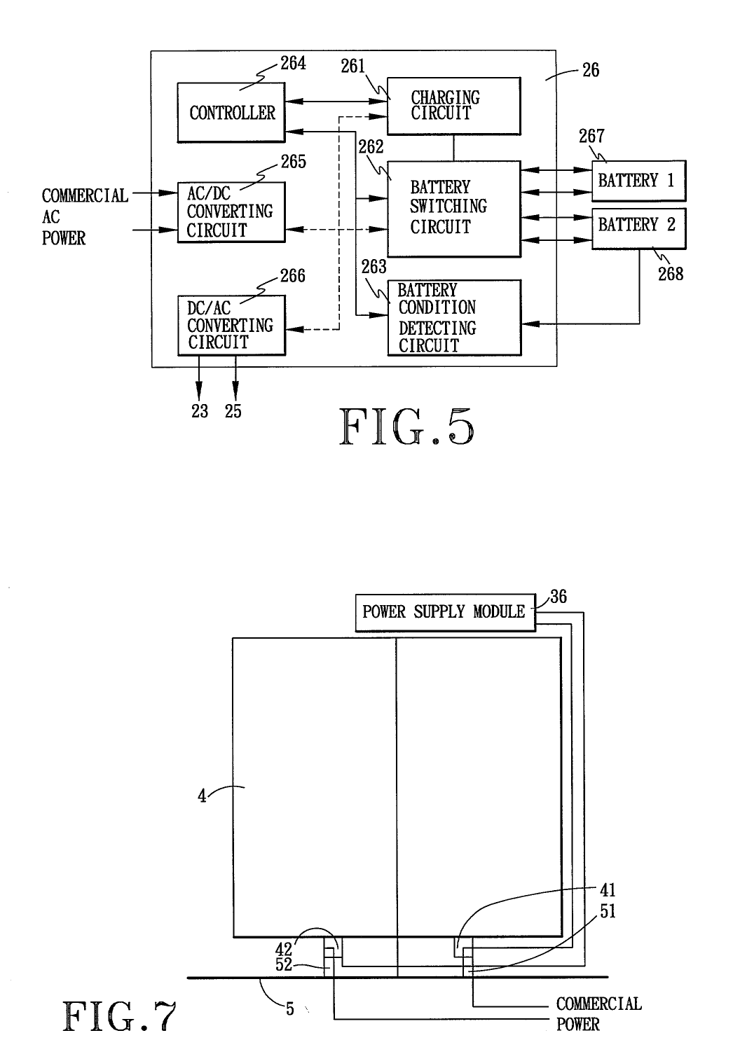

Referring to FIG. 5, the power supply module 26 includes two rechargeable batteries 267, 268, a charging circuit 261, a battery switching circuit 262 for connecting selectively the charging circuit 261 to one of the two rechargeable batteries 267, 268 so as to charge the same, a battery condition detecting circuit 263 for detecting the condition of the rechargeable batteries 267, 268, a controller 264 such as a single-chip processor connected to the circuits 261, 262, 263 for controlling charging of the rechargeable batteries 267, 268, an AC/DC converting circuit 265, and a DC/AC converting circuit 266. The controller 264 controls the charging operation of the charging circuit 261 and the switching operation of the battery switching circuit 262 in accordance with the condition of the rechargeable batteries 267, 268 as detected by the battery condition detecting circuit 263. The AC/DC converting circuit 265 is disposed to convert commercial AC power (AC85V˜AC250v) into DC power for subsequent supply to the charging circuit 261, thereby enabling the latter to commence charging of the rechargeable batteries 267, 268. The DC/AC converting circuit 266 is disposed to convert the DC power from the AC/DC converting circuit 265 or that stored in the rechargeable batteries 267, 268 into AC power for use by the control module 23 and the transceiver module 25.

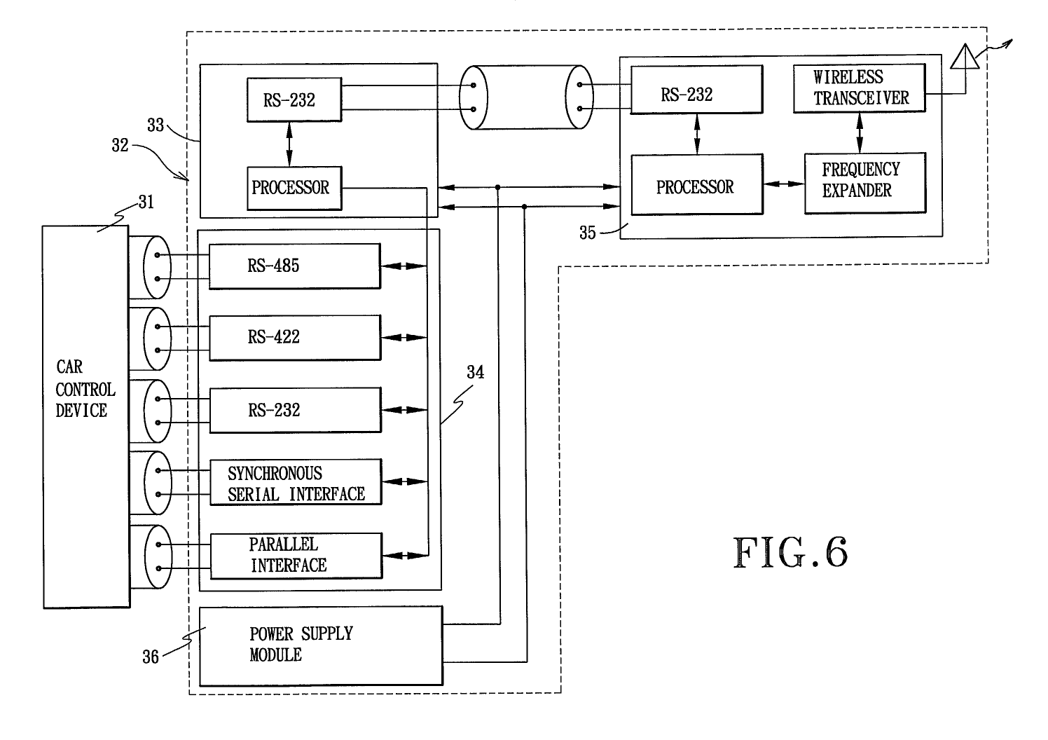

Referring to FIG. 6, the car control unit 3 includes a car control device 31 and a car transceiver device 32. The car control device 31 is already known in the art, whereas the car transceiver device 32 has an internal structure identical to that of the machine room transceiver device 22 shown in FIG. 4, and likewise includes a control module 33, a connecting interface selector 34, a transceiver module 35, and a power supply module 36. As the operation of the modules 33, 36 and 36, and the connecting interface selector 34 are the same as those of the machine room transceiver device 22, a detailed description thereof is dispensed with herein for the sake of brevity.

With further reference to FIG. 7, the power supply module 36 performs charging by utilizing two conductive plates 41, 42 that are mounted on a bottom portion of an elevator car 4, and two conductive brushes 51, 52 that are oppositely mounted on a car door guide rail 5. The two conductive plates 41, 42 are fixedly mounted so as to prevent short-circuiting. The two conductive brushes 51, 52 are movable upwardly and downwardly for purposes of buffering and charging during upward/downward movement of the elevator car 4. The conductive brush 51 is connected to a commercial power supply line, whereas the conductive brush 52 is connected to a commercial power grounding line. When the elevator car 4 is flush with a floor surface, the conductive plates 41, 42 will contact the corresponding conductive brushes 51, 52 on the car door guide rail 5 to thereby establish electrical connection. Hence, as shown in FIG. 5, commercial AC power can be supplied to the AC/DC converting circuit 265 for charging the batteries 267, 268 via the charging circuit 261 and the battery switching circuit 262. Before that, the battery condition detecting circuit 263 will first detect the conditions of the rechargeable batteries 267, 268 for output to the controller 264 so as to actuate the relevant circuits according to the following conditions:

a. When the elevator car 4 is flush with the floor surface, if both of the rechargeable batteries 267, 268 are at a predetermined saturation limit, neither will be charged.

b. When the elevator car 4 is flush with the floor surface, if one of the rechargeable batteries 267, 268 is below the predetermined saturation limit, charging will proceed quickly via the conductive plates 41, 42 and the conductive brushes 51, 52, and commercial AC power is supplied to the entire elevator car 4.

c. If the elevator car 4 is not flush with any floor surface, one of the rechargeable batteries 267, 268 will supply electric power to the entire elevator car 4.

d. If the elevator car 4 is not flush with any floor surface, and if either of the rechargeable batteries 267, 268 is below the predetermined saturation limit during movement of the elevator car 4, preparations for an immediate quick charging operation upon flushing of the elevator car 4 with the floor surface are made.

e. If one of the rechargeable batteries 267, 268 drops below a predetermined safety voltage region, replacement of the same is indicated.

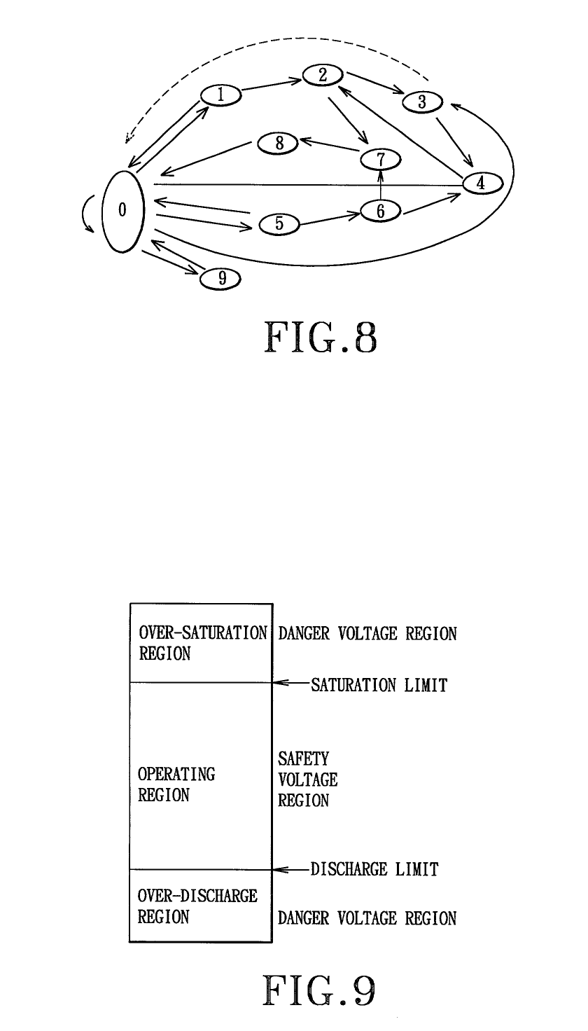

Reference is made to FIG. 8, which is a state transition diagram to illustrate operation of the power supply module 36. A change from state 0 to state 1 occurs to detect whether the rechargeable battery in use has reached a predetermined discharge limit. A change from state 1 to state 2 then occurs to detect whether the rechargeable battery in use has reached an over-discharge condition. If yes, a change from state 2 to state 7 occurs to turn off the diode indicator associated with the rechargeable battery in use, and a change from state 7 to state 8 occurs to generate an audible warning alarm, thereby indicating the need to replace the rechargeable battery in use. At the same time, a change from state 2 to state 3 occurs to switch the rechargeable battery in use to a standby mode. From state 3 to state 4, the other rechargeable battery that was originally in a standby mode is switched to a use mode. From state 4, the transition goes back to states 0 and 2. A change from state 0 to state 5 occurs to detect whether the rechargeable battery in use has reached a predetermined saturation limit. A change from state 5 to state 6 then occurs to detect whether the rechargeable battery in use has reached an over-saturated condition. If yes, a change from state 6 to states 7 and 8 occurs in the manner described above. At the same time, a change from state 6 to state 4 occurs to switch the fully charged rechargeable battery that was in a standby mode to a use mode. A change from state 0 to state 9 occurs to initiate charging of the rechargeable battery in use at the end of a door closing signal.

Referring to FIG. 9, the charging operation of the power supply module 36 is described briefly as follows:

1. Under normal conditions, one of the rechargeable batteries is used to supply electric power to the entire elevator car, while the other one of the rechargeable batteries is in a standby mode.

2. When the rechargeable battery in use has reached a predetermined discharge limit, the same is switched to a standby mode, while the rechargeable battery that was originally in the standby mode is switched to a use mode.

3. When the battery condition detecting circuit detects that the rechargeable battery in use has reached an over-discharge condition, the latter is disconnected, the diode indicator associated therewith is turned off, and the warning alarm is generated to inform the user of the need to replace the defective rechargeable battery.

4. If the rechargeable battery has been charged to a predetermined saturation limit, the fully charged battery is switched to a use mode, while the rechargeable battery that was originally in use is switched to a standby mode.

5. When the battery condition detecting circuit detects that the fully charged rechargeable battery has reached an over-saturated condition, the latter is disconnected, the diode indicator associated therewith is turned off, and the warning alarm is generated to inform the user of the need to replace the defective rechargeable battery.

6. If it is found prior to switching the fully charged rechargeable battery to the use mode that the rechargeable battery that is in use is in a saturated state, the charging circuit will be enabled to perform a pulse-charging operation, wherein charging of the battery proceeds for one second at an interval of every two seconds so as to ensure that the rechargeable battery is in the saturated state and so as to prolong the service life of the same.

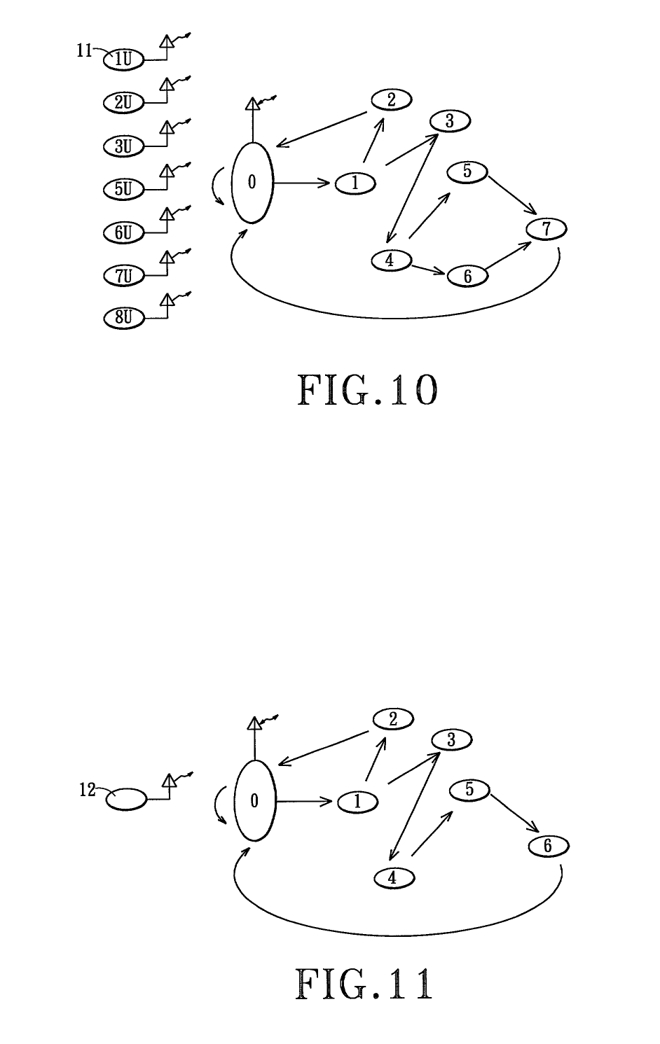

In use, when the user sends a car calling signal to the main control unit 2 using the car calling unit 11, the main control unit 2 operates according to the state transition diagram shown in FIG. 10, in which eight users (1U-8U) can simultaneously utilize their respective car calling unit 11 to summon an elevator car. In the state 0, the main control unit 2 is in a standby mode and waits for a car calling signal. When the machine room transceiver device 22 receives a car calling signal, there is a change from state 0 to state 1, wherein ID1 and ID2 of the user code are determined. If it is determined that the car calling signal is not from a legitimate user, there is a change from state 1 to state 2, where the signal is disregarded, and subsequently back to state 0. If it is determined that the car calling signal is from a legitimate user and can thus be accepted, there is a change from state 1 to state 3. From state 3, there is a change to state 4, where the car calling mode (a current floor or a specified floor) and right of priority service are determined. There is a change from state 4 to state 5 when the car calling mode corresponds to the current floor, and from state 4 to state 6 when the car calling mode corresponds to a specified floor other than the current floor. During a transition from state 5 or state 6 to state 7, the machine room transceiver device 22 sends a car dispatch signal to the car transceiver device 32 to dispatch an elevator car. From state 7, there is a transition back to state 0 once an elevator car has been dispatched.

When an elevator maintenance personnel sends a car calling signal using the car calling unit 12, the main control unit 2 operates according to the state transition diagram shown in FIG. 11, in which the state 0 indicates that the main control unit 2 is in a standby mode. When a car calling signal is received from the car calling unit 12, there is a change from state 0 to state 1 to determine the legitimacy of the signal. If it is determined that the signal is not from a legitimate maintenance personnel, there is a change from state 1 to state 2, where the signal is disregarded, and subsequently back to state 0. If it is determined that the signal is from a legitimate maintenance personnel, there is a change from state 1 to state 3, where the signal is accepted. From state 3, there is a change to state 4, where the car calling mode of the maintenance personnel is determined. Upon determination of the floor on which the maintenance personnel is located, there is a change from state 4 to state 5, where a request for an elevator car is made. From state 5, there is a change to state 6, where a car dispatch signal is sent, and back to state 0, when an elevator car is dispatched in response to the car dispatch signal.

When the machine room transceiver device 22 receives the car calling signal, it sends the car calling signal to the machine room control device 21 via one of the interfaces 241, 242, 243, 244, 245 of the connecting interface selector 24. After appropriate prioritization processing, a data packet is generated and is forwarded back to the machine room transceiver device 22, which transmits the data packet to the car transceiver device 32. After receiving the data packet transmitted from the machine room transceiver device 22, the car transceiver device 32 determines the integrity and accuracy of the data packet. Then, the car control device 31 controls the elevator car to move to a specified floor according to the car dispatch priority.

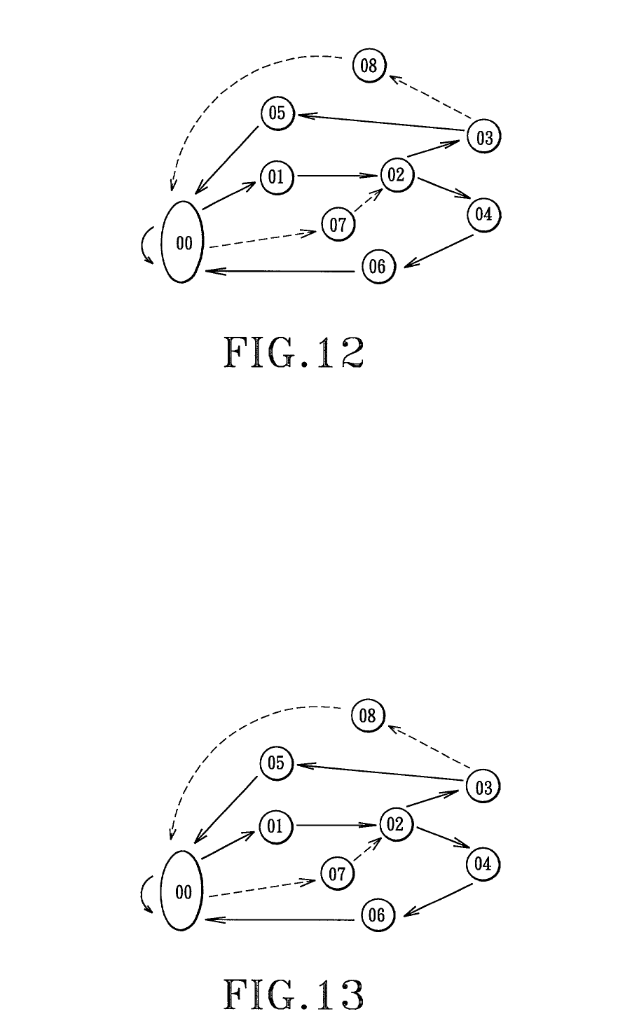

Supposing the machine room transceiver device 22 and the car transceiver device 32 have a master (MT) and slave (ST) relationship, then, the state transition diagram of the MT end is such as that shown in FIG. 12, in which when a wireless data packet is received from the car transceiver device 32, there is a change from state 00 to state 01. The integrity of the data packet is determined during a change from state 01 to state 02. The accuracy of the data packet is then determined during a change from state 02 to state 03. During a change from state 03 to state 05, the data packet is transmitted to the machine room control device 21, and the state changes back to state 00. From state 03, a change to state 08 occurs when the wireless data packet is sent to the car transceiver device 32, and back to state 00. When the MT end receives the data packet transmitted from the machine room control device 21, there is a change from state 00 to state 07. The integrity of the data packet is determined during a change from state 07 to state 02. When a data packet error is detected, there is a change from state 02 to state 04. During a change from state 04 to state 06, a signal is sent to request retransmission of the data packet, and there is a state transition back to state 00.

The state transition diagram of the ST end is illustrated in FIG. 13, in which when a wireless data packet is received from the machine room transceiver device 22, there is a change from state 00 to state 01. The integrity of the data packet is determined during a change from state 01 to state 02. The accuracy of the data packet is then determined during a change from state 02 to state 03. During a change from state 03 to state 05, the data packet is transmitted to the car control device 31, and the state changes back to state 00. From state 03, a change to state 08 occurs when the wireless data packet is sent to the machine room transceiver device 22, and back to state 00. When the ST end receives the data packet transmitted from the car control device 31, there is a change from state 00 to state 07. The integrity of the data packet is determined during a change from state 07 to state 02. When a data packet error is detected, there is a change from state 02 to state 04. During a change from state 04 to state 06, a signal is sent to request retransmission of the data packet, and there is a state transition back to state 00.

Accordingly, by providing at least one wireless car calling unit 1, and a methodology of transmitting and receiving control signals using wireless transmission between a machine room transceiver device 22 connected to a machine room control device 21 and a car transceiver device 32 connected to a car control device 31, and by arranging a power supply module 26, 36 in the machine room transceiver device 22 and the car transceiver device 32, the following can be achieved:

1. By eliminating the use of control cables between the machine room and the elevator car of the conventional elevator system, cable installation costs and maintenance costs can be reduced. Besides, the maintenance personnel are not required to go into the elevator chute when maintenance is required, which greatly enhances the safety of the relevant personnel.

2. The car calling unit 1 can be used to identify a passenger for security purposes, as well as to call an elevator car.

3. By means of the machine room control device 21, the number of passengers calling elevator service and the floors where the passengers are can be known beforehand to permit optimum service planning.

4. The elevator system incorporating the control apparatus of the present invention is able to provide personalized services for specific passengers, e.g., right of priority service, restricted car calling services for specific floors, controllable door opening/closing time, greeting services, etc.

5. The power supply module provides automatic charging to supply electric power to the elevator car. Hence, under normal conditions or during power failure, power supply to the entire elevator car and the lighting therein can be ensured. Besides, electric cables that are needed to drag the elevator car to the machine room can be reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A wireless transmission control apparatus for controlling movement of an elevator car of an elevator system that is installed in a building, said wireless transmission control apparatus comprising:
at least one wireless car calling unit operable so as to transmit a car calling signal wirelessly;
a main control unit associated with a machine room of the elevator system and including a machine room transceiver device for receiving the car calling signal transmitted by said wireless car calling unit, said main control unit determining whether the car calling signal is legitimate, and disregarding the car calling signal that is deemed not to be legitimate, said main control unit further determining a right of priority service for the car calling signal that is deemed to be legitimate, and wirelessly transmitting a car dispatch signal corresponding to the car calling signal that is deemed to be legitimate; and
a car control unit associated with the elevator car and including a car transceiver device for receiving the car dispatch signal transmitted by said main control unit, said car control unit being adapted to control the elevator car to move to a specific floor of the building in response to the car dispatch signal.

2. The wireless transmission control apparatus of claim 1, wherein said car calling signal contains at least user identity and floor information.

3. The wireless transmission control apparatus of claim 1, wherein each of said machine room transceiver device and said car transceiver device includes a wireless transceiver and a frequency expander connected to said wireless transceiver and capable of automatic frequency skipping so as to select and skip to a channel that is available for signal transmission by said wireless transceiver in order to minimize signal interference.

4. The wireless transmission control apparatus of claim 1, wherein said car transceiver device includes:
at least two rechargeable batteries;
a charging circuit;
a battery switching circuit for connecting selectively said charging circuit to one of said rechargeable batteries so as to charge said one of said rechargeable batteries;
a battery condition detecting circuit for detecting condition of said rechargeable batteries;
a controller connected to said charging circuit, said battery switching circuit and said battery condition detecting circuit, said controller controlling charging operation of said charging circuit and switching operation of said battery switching circuit in accordance with the condition of said rechargeable batteries as detected by said battery condition detecting circuit;
an AC/DC converting circuit for converting commercial AC power into DC power that is supplied to said charging circuit; and
a DC/AC converting circuit for converting DC power from one of said AC/DC converting circuit and said one of said rechargeable batteries into AC power.

5. A power supply module for a wireless transmission apparatus, comprising:
at least two rechargeable batteries;
a charging circuit;
a battery switching circuit for connecting selectively said charging circuit to one of said rechargeable batteries so as to charge said one of said rechargeable batteries;
a battery condition detecting circuit for detecting condition of said rechargeable batteries;
a controller connected to said charging circuit, said battery switching circuit and said battery condition detecting circuit, said controller controlling charging operation of said charging circuit and switching operation of said battery switching circuit in accordance with the condition of said rechargeable batteries as detected by said battery condition detecting circuit;
an AC/DC converting circuit for converting commercial AC power into DC power that is supplied to said charging circuit; and
a DC/AC converting circuit for converting DC power from one of said AC/DC converting circuit and said one of said rechargeable batteries into AC power.
